(19) United States
(12) Patent Application Publication
(10) Pub. No.: US 2016/0267797 A1
(43) Pub. Date: Sep. 15, 2016

(54) METHOD AND DEVICE FOR DETECTING OBSTACLES

(71) Applicant: Frank SPIRGATIS, Hannover (DE)

(72) Inventor: Frank SPIRGATIS, Hannover (DE)

(21) Appl. No.: 15/033,950

(22) PCT Filed: Oct. 29, 2014
(86) PCT No.: PCT/DE2014/000554

§ 371 Date: May 3, 2016

(30) Foreign Application Priority Data
Nov. 4, 2013 (DE) 10 2013 018 762.1

(51) Int. Cl. G08G 5/04; G01S 13/93; G08G 5/00

(52) U.S. Cl. CPC G08G 5/045; G08G 5/0086; G08G 5/0021; G01S 13/9303

(57) ABSTRACT

A method and a device for detecting obstacles during operation of an aircraft. Using at least one sensor, environment data are detected and visualized on at least one display. The data are processed by at least one control unit. The control unit is in the form of a single-processor system having at least one core.

The invention relates to a method for detecting obstacles during operation of an aircraft, in which environment data are acquired using at least one sensor and are visualized on at least one display, and in which the data are processed by at least one computing unit and man-machine interaction is controlled by at least one computing unit.

The invention also relates to a device for detecting obstacles during operation of an aircraft, which has at least one sensor for acquiring environment data and is provided with at least one display for visualizing the data and has at least one computing unit for processing the data and at least one computing unit for man-machine interaction.

The invention is designed, in particular, for operation in motorized aircraft.

The previously known methods and devices for detecting obstacles give rise to considerable costs both during implementation and during operation. Therefore, these methods and devices are not suitable for use in small private aircraft, in particular in so-called ultralight aircraft.

The object of the present invention is to develop a method and a device of the type mentioned in the introductory part in such a manner that high-quality and simultaneously energy-efficient and economical obstacle detection is supported.

The device according to the invention is a distributed system in which a plurality of computing units each undertake a defined task in the overall system.

An operating system is used on each computing unit. The operating system is also executable on single-core processor architectures and therefore does not meet any special requirements of a multi-core processor. In addition, it need not meet the requirements of a real-time system.

All computing units are connected to one another via a BUS (Binary Unit System).

Each computing unit contains an executable program which receives data from the BUS, processes said data and outputs its own data to the BUS.

The programs on the computing units ensure that all data are available for all computing units via the BUS.

The following variants of the system can be implemented:
There is at least one sensor for acquiring environment data. This sensor is connected to a computing unit on which the data are acquired and processed using an executable program. The computing unit is connected to a BUS, to which the data are output and from which it receives data in order to process them.
There is at least one display for visualizing the data. This display is in the form of a head-up display and is connected to a computing unit. This computing unit receives data from the BUS using an executable program, processes said data and visualizes them on the display.

As a result of the data being visualized on a connected head-up display, the pilot has all necessary information in his main field of view.

Instead of the head-up display, it is also possible to use other suitable displays for visualization, for instance glasses suitable for displaying electronic data.
There is a control device which is connected to the BUS. In said control device, data are received from the BUS and are processed and transferred to the BUS. The task of the control device is to set up and control the entire distributed system and to provide data for visualization. The control device also has the task, in particular, of ensuring man-machine interaction. Possible hardware forms for the control device are a tablet PC or another type of embedded system.

Exemplary embodiments of the invention are schematically illustrated in the drawings, in which:

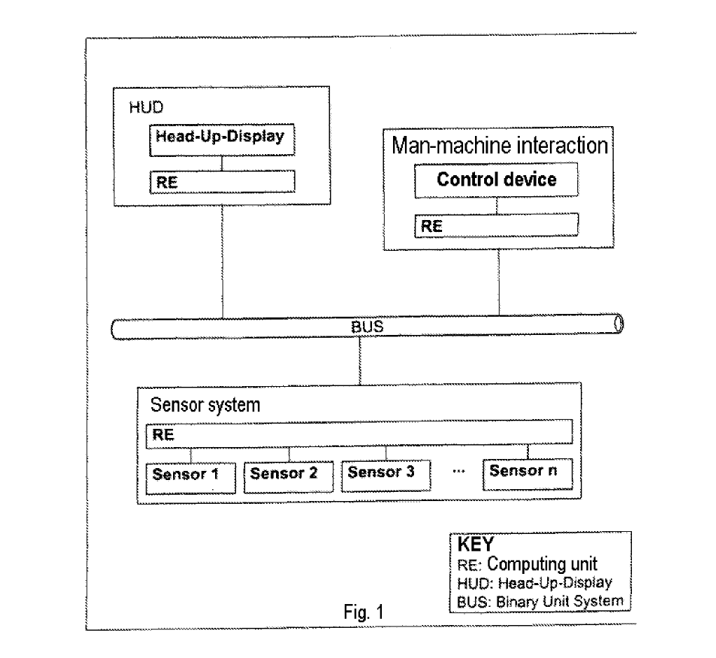

FIG. 1 shows a simplified illustration of an overview of one variant of a distributed overall system,

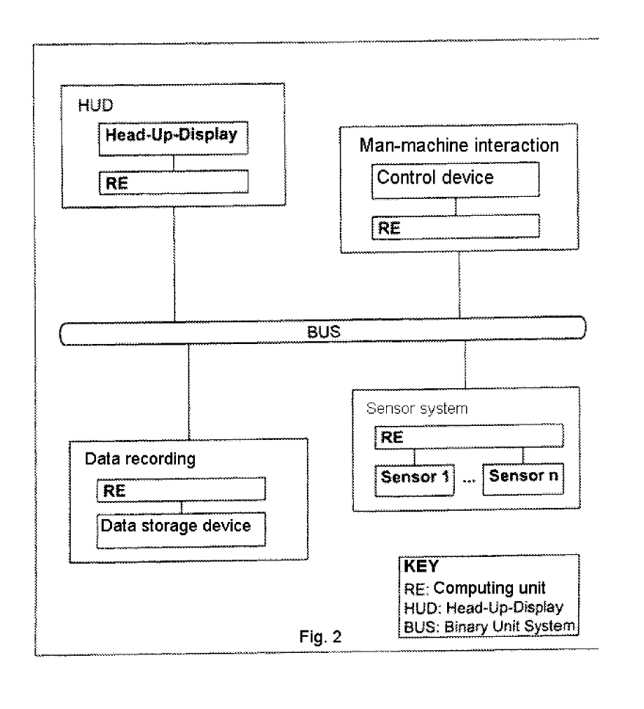

FIG. 2 shows a further graphical variant of a distributed system,

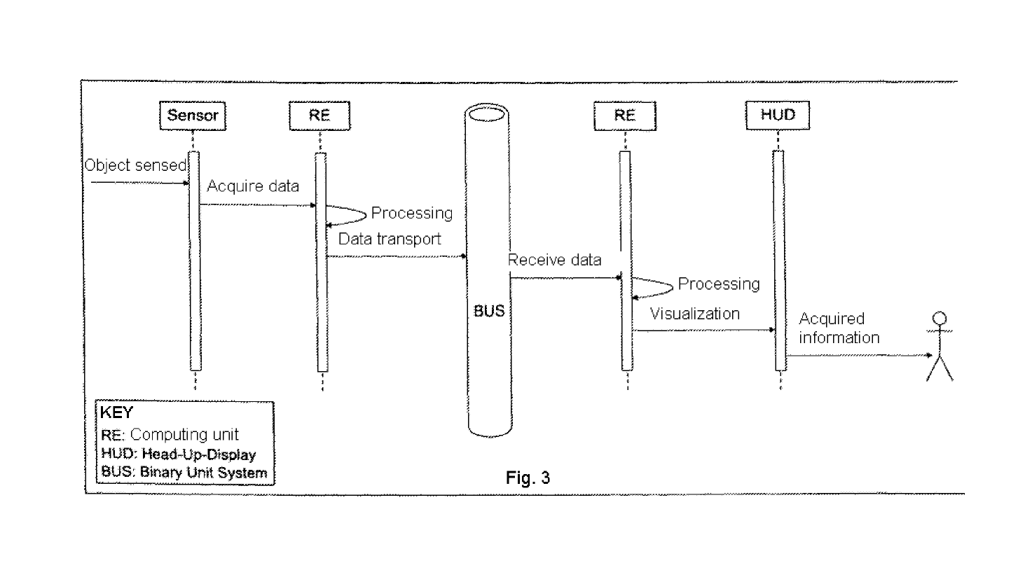

FIG. 3 shows an illustration for illustrating a first variant of the method sequence, and

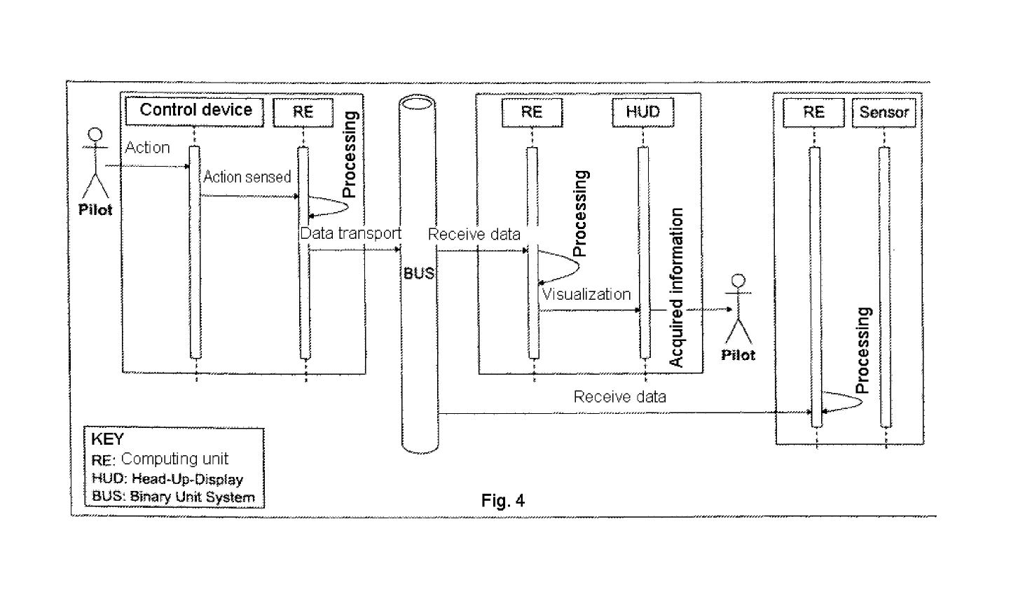

FIG. 4 shows a diagram for illustrating another variant of the method sequence.

FIG. 1 contains the three components “head-up display”, “man-machine interaction” and “sensor system” (variant A).

FIG. 2 shows that the invention can be expanded with further components having defined tasks, here “data recording”, for example (variant B).

FIGS. 3 and 4 show, by way of example, two implemented method sequences.

FIG. 3 illustrates how an object sensed using a sensor is processed and is visualized on the head-up display.

FIG. 4 shows how an operator interacts with the system via the control device and how these data are received and processed by the computing units of other components, for example the head-up display and the sensor system.

The hardware components of the invention are distinguished by the following properties:
Operating temperature: 0-50° C.
Maximum loading: 3.5 g
Protection type according to DIN EN 60529: IP20

The invention operates using a single-processor system having at least one processor core. The advantages of this system over multi-processor systems are a lower energy requirement and only passive cooling since the amount of computing power required is much lower if the coordination between a plurality of physical processors is dispensed with. Further advantages are a smaller size and lower costs.

The object of the invention is, in particular, to acquire and process data from the aircraft and its environment using peripheral equipment and to visualize the data on a head-up display.

As a result of the invention, data indicating the pilot's current flight attitude are visualized for the pilot. The possibility of being able to acquire, combine and calculate data from the aircraft and its environment makes the use for a pilot worthwhile since dangerous situations, for example, can be determined by calculating new data.

Another object of the invention is to ensure that all received data are recorded and that these data are extracted from the system.

The use of the invention does not require active intervention in the systems of the aircraft. It is a purely passive system which acquires, processes and visualizes data.

The aircraft used according to the invention is, in particular, a motorized aircraft. According to one embodiment, it is an airplane.

According to FIG. 1, the computing units of the components “head-up display”, “man-machine interaction” and “sensor system” undertake subtasks in the overall system and transmit data to one another via a BUS.

According to FIG. 2, the invention can be expanded with further components having defined tasks—here: data recording on a separate data storage device. The new component is connected to the other components by means of the BUS.

According to FIG. 3, an object is sensed by a sensor. Data relating to the object are processed by a computing unit and are forwarded to other computing units via a BUS. The data are received, for example, by the computing unit of the head-up display in order to then be visualized on the head-up display.

According to FIG. 4, the pilot interacts with the system via the control device by confirming a warning message, for example. The data from the control device are processed by a computing unit and are forwarded via a BUS. The data are received and processed by the computing units of the components “head-up display” and “sensor system”. As a result, the information displayed on the display and the data processing in the component “sensor system” change, for example.

The control and configuration are on a computer with a user interface. Said is computer is connected to the network comprising decentralized computing units. Each of these computing units has a defined task to perform in the system and is therefore equipped with corresponding software. For example, the head-up display is connected to one of the computing units. Data which are intended for this computing unit (HUD) are understood, processed, possibly preprocessed and visualized.

As a result of its configuration, each of the computing units is able to perform a particular task. Furthermore, it is also able to undertake the tasks of other computing units by being accordingly configured. Since the intelligence of the entire system was based on a decentralized distributed system, there is no need for central processing and decision-making by a central unit. For example, as a result of failure of the MMI group, the remaining system is still able to analyze critical values and to display corresponding warnings on the HUD.

One of the computing units of the system is responsible for equipping the distributed system with a configuration in the initial activation phase. The tasks, limit values and behavioral rules for data are stored in the configuration.

1-18. (canceled)

19. A method for detecting obstacles during operation of an aircraft, the method comprising the steps of acquiring environment data using at least one sensor; displaying the environment data on at least one display, and processing the data by at least one control unit, wherein the control unit is a single-processor system having at least one core.

20. The method as claimed in claim 19, wherein the sensor is a radar system.

21. The method as claimed in claim 19, wherein a single sensor is used.

22. The method as claimed in claim 19, further including recording flight data.

23. The method as claimed in claim 19, further including extracting data.

24. The method as claimed in claim 19, further including carrying out GPS navigation.

25. The method as claimed in claim 19, further including carrying out 3G position detection.

26. The method as claimed in claim 19, wherein the single-processor system has exactly one core.

27. The method as claimed in claim 19, wherein the control unit is a tablet PC.

28. The method as claimed in claim 19, wherein the display is a head-up display.

29. The method as claimed in claim 19, including using an open-source program as an operating system for the control unit.

30. A device for detecting obstacles during operation of an aircraft, comprising: at least one sensor for acquiring environment data; at least one display for visualizing the data; and at least one control device for processing the data, wherein the control unit is a single-processor system having at least one core.

31. The device as claimed in claim 30, wherein the sensor is a radar system.

32. The device as claimed in claim 30, having exactly one sensor.

33. The device as claimed in claim 30, wherein the single-processor system has exactly one core.

34. The device as claimed in claim 30, wherein the control unit is a tablet PC.

35. The device as claimed in claim 30, wherein the display is a head-up display.

36. The device as claimed in claim 30, wherein an open-source program is an operating system for the control device.
